(19) United States
(12) Patent Application Publication
(10) Pub. No.: US 2009/0042538 A1
(43) Pub. Date: Feb. 12, 2009

(54) METHOD FOR OBTAINING PACKET BILLING INFORMATION BASED ON SESSION INITIATION PROTOCOL

(75) Inventors: Hyeon Cheol Cho, Gyeonggi (KR); Sang Geun Hwang, Gyeonggi (KR); Chang Wook Lee, Incheon (KR); Il Hyung Rhee, Gyeonggi (KR)

Correspondence Address: BLANK ROME LLP, 600 NEW HAMPSHIRE AVENUE, N.W., WASHINGTON, DC, 20037, US

(73) Assignee: POSDATA CO., LTD

(21) Appl. No.: 12/282,978

(22) PCT Filed: Apr. 12, 2007
(86) PCT No.: PCT/KR07/01769

§ 371 Date: Sep. 15, 2008

(30) Foreign Application Priority Data
Apr. 13, 2006 (KR) 10-2006-0033547

(51) Int. Cl. H04M 11/00

(52) U.S. Cl. 455/406

(57) ABSTRACT

Disclosed is a method for controlling billing in a Session Initiation Protocol (SIP) call server The method includes the steps of: receiving an invite message from a calling SIP terminal; transmitting a (100) trying message to the calling SIP terminal, the (100) trying message including transmission period information of a keep-alive message; establishing an SIP call between the calling SIP terminal and a called SIP terminal, and receiving the keep-alive message from the calling SIP terminal in the transmission period, the keep-alive message including billing information; and when the SIP call is terminated, transmitting final billing information received from the calling SIP terminal to a billing server.

### TECHNICAL FIELD

The present invention relates to a method for controlling billing in a Session Initiation Protocol (SIP) call server, and more particularly, to a method for controlling billing in an SIP call server, which enables reasonable billing based on an actually used amount of packets and minimized waste of communication network resources by controlling SIP call establishment through a check of a keep-alive state of a calling SIP terminal in a predetermined period, receiving, from the calling SIP terminal or a called SIP terminal, packet billing information accumulated in the calling SIP terminal as the SIP call is established, and calculating billing information for the calling SIP terminal.

### BACKGROUND ART

On recent mobile communication networks, a line-based mobile phone service is provided. As a data transmission speed of a next-generation mobile communication network using an All-IP increases, high-speed bidirectional data service can be provided. An existing mobile communication network has gradually evolved into the All-IP network.

More advanced communication systems are being developed to provide packet transmission-based communication service on a mobile communication network which is a packet network. Among the advanced communication systems, VoIP is based on protocols, such as H.323, Session Initiation Protocol (SIP), Media Gateway Control Protocol (MGCP), and the like, in order to enable voice calls and video calls.

However, most VoIP protocols are being developed for communications on a wired network. In particular, in a VoIP call based on Session Initiation Protocol (SIP), a keep-alive state between a call server and a terminal is not checked during communication.

FIG. 2(a) is a flowchart illustrating a conventional method for controlling billing in an SIP call server.

When a user of a calling SIP terminal dials to establish an SIP call, the calling SIP terminal transmits an SIP call initiation message, i.e., an invite message to the SIP call server (step 211). The SIP call server then transmits an invite message corresponding to the invite message received from the calling SIP terminal, to a called SIP terminal (step 212). The SIP call server also transmits a 100 trying message to the calling SIP terminal to inform that it is ready to perform SIP call establishment (step 213).

Upon receipt of the invite message from the SIP call server, the called SIP terminal rings a bell and simultaneously transmits a 180 Ringing message to the SIP call server in order to inform that the SIP call can be established (step 214). The SIP call server delivers the 180 Ringing message to the calling SIP terminal (step 215). Upon receipt of the 180 Ringing message, the calling SIP terminal outputs a ringback tone.

When a user of the called SIP terminal hooks off, the called SIP terminal transmits a 200 OK message to the SIP call server in order to attempt to establish the SIP call (step 216). The SIP call server delivers the 200 OK message to the calling SIP terminal (step 217).

The calling SIP terminal transmits an ACK message to the SIP call server in order to inform that a final response message, i.e., a 200 OK message to the invite message, has been received (step 218), and the SIP call server delivers the ACK message to the called SIP terminal (step 219).

A communication path is established, i.e., busy, and the calling SIP terminal and the called SIP terminal transmit and receive RTP media packets to and from each other so that a voice call and video call for the SIP call are established (step 220).

When the calling SIP terminal user hooks on, the calling SIP terminal transmits a BYE message to the SIP call server in order to terminate the SIP call (step 221). The SIP call server transmits a response message, i.e., a 200 OK message to the calling SIP terminal (step 222) and the BYE message to the called SIP terminal (step 223). The called SIP terminal transmits a 200 OK message to the SIP call server in response to the BYE message (step 224), thereby terminating the SIP call.

As described above, in a conventional VoIP call, particularly, an SIP call, a keep-alive state between the call server and the terminal is not checked during communication. Accordingly, when the SIP call is served on a wireless network, i.e., a mobile communication network, and when the call is abnormally terminated due to a reason not recognized by the subscriber, only the call establishment between the VoIP mobile terminal and the base station system is released. That is, the SIP call server does not receive an SIP call termination message from the VoIP mobile terminal.

Since the SIP call server recognizes that the subscriber is under communication, it is impossible to obtain billing information, such as actual use time of the VoIP call and an amount of packets. Further, since the correspondent subscriber maintains the call, resources of the mobile communication network are wasted.

Furthermore, when a node generating packet billing information is powered on, it periodically generates billing information from session initiation when a mobile IP is registered to session termination when the mobile IP is released. Accordingly, when an SIP-based VoIP mobile terminal uses data service and VoIP call service within such a period, the billing information includes packet amount information for the two services. That is, only the billing information of the VoIP call is not separated. This makes it difficult to obtain billing information of specific service.

There is a need for a VoIP billing control method which allows a call to be optimally established on a wired network and a mobile communication network by obtaining reasonable billing information through a check of a keep-alive state between a call server and a terminal during communication.

### DISCLOSURE OF INVENTION

Technical Problem

The present invention is directed to a method for controlling billing in an SIP call server, which enables billing control based on an amount of actually transmitted and received packets, not an SIP call establishment time, by controlling billing for a calling SIP terminal based on packet amount information included in a BYE message received from the calling SIP terminal when an SIP call between the calling SIP terminal and a called SIP terminal is terminated.

The present invention is also directed to a method for controlling billing in an SIP call server, which enables billing even in a mobile communication network by periodically checking an SIP call establishment state (Keep Alive) of a calling SIP terminal and receiving accumulated billing information for the SIP call establishment from the calling SIP terminal to control billing for the calling SIP terminal.

The present invention is also directed to a method for controlling billing in an SIP call server, which enables efficient use of a communication network and rational billing by controlling SIP call termination and performing billing for a calling SIP terminal based on accumulated billing information received from a called SIP terminal when the calling SIP terminal does not receive an RTP media packet from the called SIP terminal for a predetermined time after the SIP call is established.

The present invention is also directed to a method for controlling billing in an SIP call server, which is capable of performing separate billing based on billing information of an SIP call and packet billing information of other data service without a modification to an existing mobile communication packet network by calculating packet billing information based on accumulated billing information included in a message transmitted upon SIP call termination.

The present invention is also directed to a method for controlling billing in an SIP terminal which is capable of enabling more reasonable billing by measuring an amount of data packets transmitted to and an amount of data packets from a correspondent SIP terminal, recording information on the measured packet amount in additional fields of various messages under SIP call establishment control, and transmitting it to an SIP call server when the SIP call is established.

The present invention is also directed to a method for controlling billing in an SIP terminal which is capable of reducing a charge and minimizing waste of network resources by determining that an SIP call fails and then terminating the SIP call when an RTP media packet is not received from a correspondent SIP terminal for a predetermined period of time after the SIP call is established.

Technical Solution

One aspect of the present invention provides a method for controlling billing in a Session Initiation Protocol (SIP) call server, the method comprising the steps of: receiving an invite message from a calling SIP terminal; transmitting a 100 trying message to the calling SIP terminal, the 100 trying message including transmission period information of a keep-alive message; establishing an SIP call between the calling SIP terminal and a called SIP terminal, and receiving the keep-alive message from the calling SIP terminal in the transmission period, the keep-alive message including billing information; and when the SIP call is terminated, transmitting final billing information received from the calling SIP terminal to a billing server.

Another aspect of the present invention provides a method for controlling billing in an SIP call server, the method comprising the steps of: receiving an invite message from a calling SIP terminal to establish an SIP call; transmitting a 100 trying message to the calling SIP terminal, the 100 trying message including transmission period information of a keep-alive message; when the SIP call is established between the calling SIP terminal and a called SIP terminal, determining whether the keep-alive message is received from the calling SIP terminal in the transmission period, and transmitting a BYE message to the called SIP terminal when the keep-alive message is not received in the transmission period; receiving a 200 OK message including billing information from the called SIP terminal; and transmitting the billing information to a billing server.

Still another aspect of the present invention provides a method for controlling billing in an SIP call server, the method comprising the steps of: receiving an invite message from a calling SIP terminal; transmitting a 100 trying message to the calling SIP terminal, the 100 trying message including transmission period information of a keep-alive message; establishing an SIP call between the calling SIP terminal and a called SIP terminal, and receiving the keep-alive message from the calling SIP terminal in a transmission period, the keep-alive message including billing information; controlling termination of the SIP call when the keep-alive message is not received from the calling SIP terminal in the transmission period and a BYE message is not received for a predetermined time; and transmitting billing information included in a final keep-alive message received from the calling SIP terminal to a billing server.

Yet another aspect of the present invention provides a method for controlling billing in an SIP call server, the method comprising the steps of: controlling SIP call establishment between a calling SIP terminal and a called SIP terminal; controlling termination of the SIP call when a BYE message including billing information for the SIP call establishment is received from the calling SIP terminal; and transmitting the billing information to a billing server.

Yet another aspect of the present invention provides a method for controlling billing in an SIP terminal, the method comprising the steps of: measuring an amount of data packets transmitted to a called SIP terminal and an amount of data packets received from the called SIP terminal when an SIP call is established with the called SIP terminal; and transmitting a BYE message to an SIP call server to terminate the SIP call when an SIP call termination event is generated, wherein the BYE message comprises billing information including a finally accumulated amount of packets.

Yet another aspect of the present invention provides a method for controlling billing in an SIP terminal, the method comprising the steps of: receiving a 100 trying message including transmission period information of a keep-alive message from an SIP call server, the SIP call server controlling an SIP call establishment with a called SIP terminal; measuring an amount of data packets transmitted to the called SIP terminal and an amount of data packets received from the called SIP terminal in the transmission period when the SIP call is established with the called SIP terminal; and transmitting the keep-alive message to the SIP call server in the transmission period, wherein the keep-alive message comprises billing information including the measured amount of data packets.

Yet another aspect of the present invention provides a method for controlling billing in an SIP terminal, the method comprising the steps of: measuring an amount of data packets transmitted to the calling SIP terminal and an amount of data packets received from the calling SIP terminal when an SIP call is established with the calling SIP terminal; receiving a BYE message from an SIP call server to terminate the SIP call; and transmitting a 200 OK message to the SIP call server, wherein the 200 OK message comprises billing information including a finally accumulated and measured amount of packets.

In this disclosure, a 100 trying message, contents of a BYE message, a 200 OK message, and an INFO message may be written using application/sdp, text, or html. For convenience of illustration, it is assumed that the 100 trying message, the BYE message, the 200 OK message, and the INFO message have a text-based format.

Advantageous Effects

According to the method for controlling billing in an SIP call server, reasonable billing control can be performed based on an amount of actually transmitted and received packets, not an SIP call establishment time by controlling billing for a calling SIP terminal based on packet amount information included in a BYE message received from the calling SIP terminal when an SIP call between the calling SIP terminal and a called SIP terminal is terminated.

According to the method for controlling billing in an SIP call server, reasonable billing can be performed even in a mobile communication network by periodically checking an SIP call establishment state (Keep Alive) of a calling SIP terminal and receiving accumulated billing information for the SIP call establishment from the calling SIP terminal to control billing for the calling SIP terminal.

According to the method for controlling billing in an SIP call server, efficient use of a communication network and reasonable billing can be performed by controlling SIP call termination and performing billing for a calling SIP terminal based on accumulated billing information received from a called SIP terminal when the calling SIP terminal does not receive an RTP media packet from the called SIP terminal for a predetermined period of time after the SIP call is established.

According to the method for controlling billing in an SIP call server, separate billing can be performed based on billing information of an SIP call and packet billing information of other data service without a modification to an existing mobile communication packet network by calculating packet billing information based on accumulated billing information included in a message transmitted upon SIP call termination.

According to the method for controlling billing in an SIP terminal, more reasonable billing can be performed by measuring an amount of data packets transmitted and received to and from a correspondent SIP terminal, recording information on the measured packet amount in additional fields of various messages under SIP call establishment control, and transmitting it to an SIP call server when the SIP call is established.

According to the method for controlling billing in an SIP terminal, a charge can be reduced and waste of network resources can be minimized by determining that an SIP call fails and then terminating the SIP call when an RTP media packet is not received from a correspondent SIP terminal for a predetermined period of time after the SIP call is established.

### BRIEF DESCRIPTION OF THE DRAWINGS

FIG. 1 is a block diagram illustrating a configuration of a system in which an SIP call is established over a mobile communication network according to the present invention;

FIG. 2(a) is a flowchart illustrating a conventional method for controlling billing in an SIP call server;

FIG. 2(b) illustrates a structure of a BYE message according to a first exemplary embodiment of the present invention;

FIG. 3 is a flowchart illustrating a method for controlling billing in an SIP call server according to the first exemplary embodiment of the present invention;

FIG. 4 illustrates an exemplary format of a 100 trying message according to the first exemplary embodiment of the present invention;

FIG. 5 illustrates an exemplary format of an INFO message according to the first exemplary embodiment of the present invention;

FIG. 6 illustrates an exemplary format of a 200 OK message according to the first exemplary embodiment of the present invention;

FIG. 7 illustrates an exemplary format of a BYE message according to the first exemplary embodiment of the present invention;

FIG. 8 is a flowchart illustrating a method for controlling billing in an SIP call server according to a second exemplary embodiment of the present invention;

FIG. 9 is a flowchart illustrating a method for controlling billing in an SIP call server according to a third exemplary embodiment of the present invention;

FIG. 10 illustrates an exemplary format of a BYE message according to the third exemplary embodiment of the present invention;

FIG. 11 illustrates an exemplary format of a 200 OK message according to the third exemplary embodiment of the present invention; and

FIG. 12 is a flowchart illustrating a method for controlling billing in an SIP call server according to a fourth exemplary embodiment of the present invention.

### DESCRIPTION OF MAJOR ELEMENTS APPEARING IN THE ABOVE FIGURES

111: Calling SIP terminal

112: Called SIP terminal

121, 122: Base station

131, 132: Base station controller

140: Packet data serving node

150: SIP call server

160: Billing server

### MODE FOR THE INVENTION

Exemplary embodiments of the present invention will be described in detail with reference to the accompanying drawings.

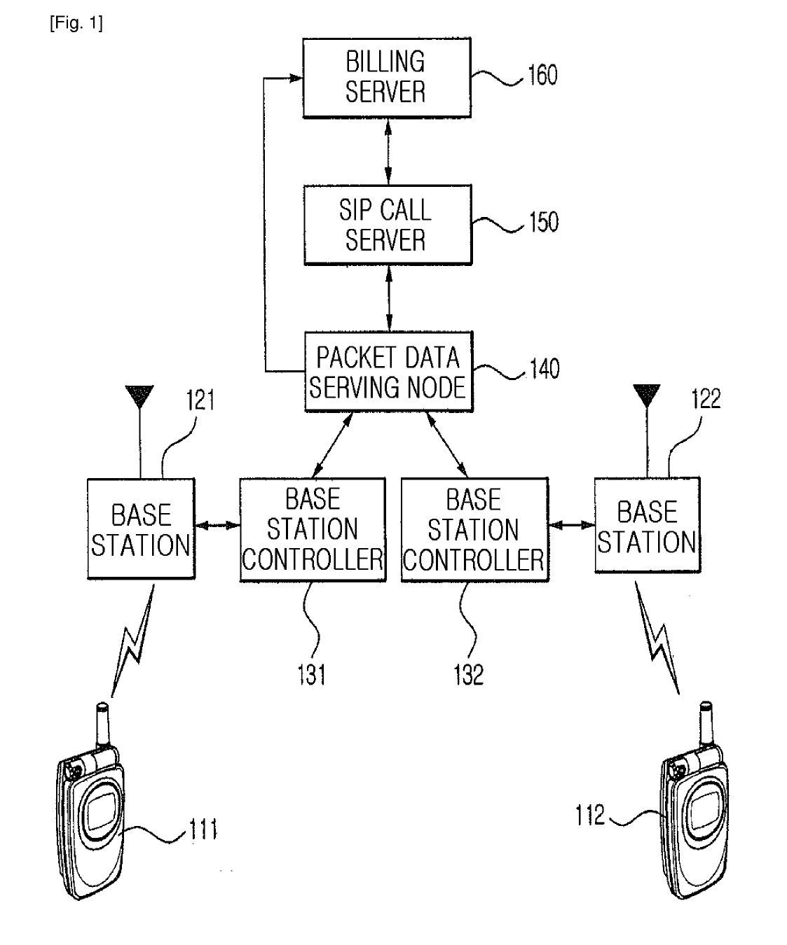

FIG. 1 is a block diagram illustrating a configuration of a system in which an SIP call is established over a mobile communication network according to the present invention.

Referring to FIG. 1, a method for controlling billing in an SIP call server according to the present invention may be implemented by operation of a calling SIP terminal 111, a called SIP terminal 112, base stations 121 and 122, base station controllers 131 and 132, a packet data serving node 140, an SIP call server 150, and a billing server 160.

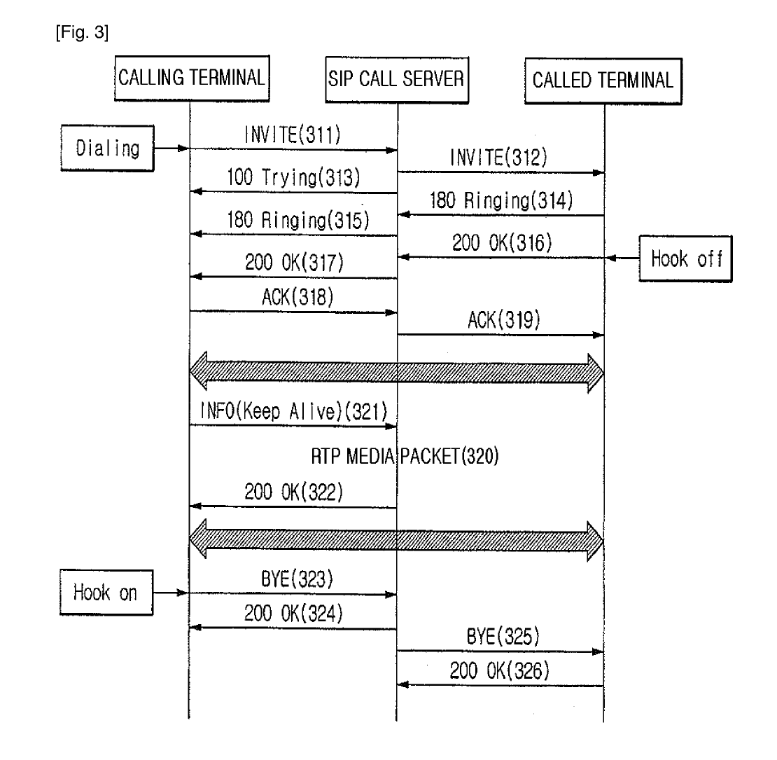

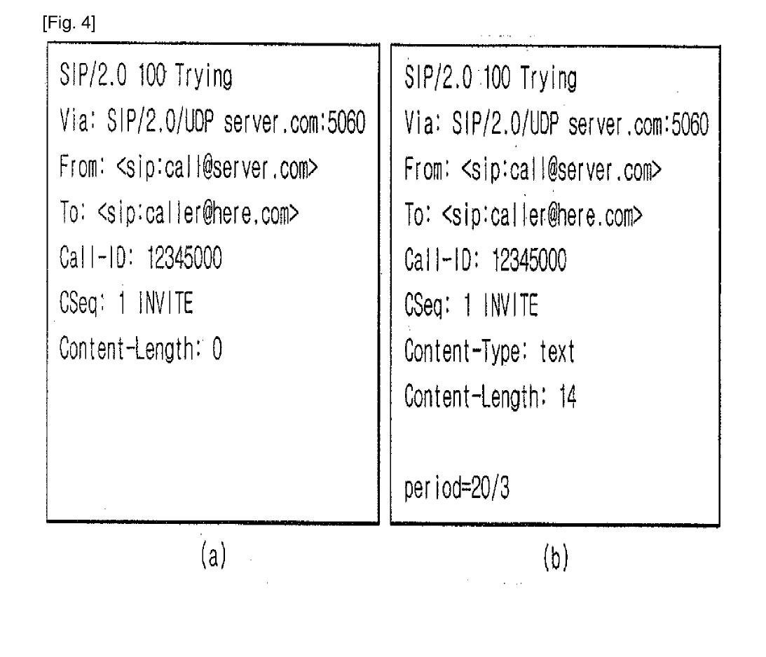

According to an exemplary embodiment of the present invention, the method for controlling billing in an SIP call server may be implemented on a mobile communication network. Accordingly, the calling SIP terminal 111 and the called SIP terminal 112 may be mobile communication terminals with an SIP call establishing function. Alternatively, the calling SIP terminal 111 and the called SIP terminal 112 may be any terminals with an SIP call establishing function, such as VoIP terminals, personal computers (PCs), or notebook computers. For convenience of illustration, it is assumed that the calling SIP terminal 111 and the called SIP terminal 112 are the mobile communication terminals. The calling SIP terminal 111 and the called SIP terminal 122 may transmit and receive messages to and from the SIP call server via the base stations 121 and 122, the base station controllers 131 and 132, and the packet data serving node 140. This process is well known to those skilled in the art, and accordingly, a detailed description of the base stations 121 and 122, the base station controllers 131 and 132, and the packet data serving node 140 will be omitted. The billing server 160 performs billing on the calling SIP terminal 111 based on billing information which is received from the SIP call server 150. Exemplary embodiments of the method for controlling billing in the SIP call server 150 in the system comprising the calling SIP terminal 111, the called SIP terminal 122, and the SIP call server 150 according to the present invention will now be described. FIG. 3 is a flowchart illustrating a method for controlling billing in an SIP call server according to a first exemplary embodiment of the present invention. In the first exemplary embodiment of the present invention, the method for controlling billing in an SIP call server when an SIP call established between the calling SIP terminal and the called SIP terminal is normally terminated as a user of the calling SIP terminal hooks on will be described. When the user of the calling SIP terminal dials to establish an SIP call, the calling SIP terminal transmits an SIP call initiation message, i.e., an invite message to the SIP call server (step 311). Herein the meaning of call may include sessions. The SIP call server then transmits an invite message, which includes a content of the invite message received from the calling SIP terminal, to the called SIP terminal (step 312). The SIP call server also transmits a 100 trying message to the calling SIP terminal to inform that it is ready to perform SIP call establishment (step 313). The 100 trying message includes information on a transmission period of a keep-alive message that the calling SIP terminal transmits during communication. This will be described in detail with reference to FIG. 4.

FIG. 4 illustrates an exemplary format of a 100 trying message according to the first exemplary embodiment of the present invention.

FIG. 4(a) shows a format of a 100 trying message which includes only a content defined in a general SIP standard, and FIG. 4(b) shows a format of a 100 trying message according to the present invention. In FIG. 4(b), the 100 trying message includes information on a transmission period of a keep-alive message that the calling SIP terminal transmits to the SIP call server during the SIP call establishment.

As shown in FIG. 4(b), the transmission period information may be implemented as “period=20/3”. This implies that the keep-alive message is to be transmitted continuously three times per 20 seconds. The transmission period information of the keep-alive message included in the 100 trying message may be modified and managed by the SIP call server.

Referring back to FIG. 3, upon receipt of the invite message from the SIP call server, the called SIP terminal rings a bell and simultaneously transmits a 180 Ringing message to the SIP call server in order to inform that the SIP call can be established (step 314). The SIP call server delivers the 180 Ringing message to the calling SIP terminal (step 315). Upon receipt of the 180 Ringing message, the calling SIP terminal outputs a ringback tone.

When a user of the called SIP terminal hooks off, the called SIP terminal transmits a 200 OK message to the SIP call server in order to attempt to establish the SIP call (step 316). The SIP call server delivers the 200 OK message to the calling SIP terminal (step 317).

The calling SIP terminal transmits an ACK message to the SIP call server in order to inform that a final response message, i.e., a 200 OK message to the invite message has been received (step 318), and the SIP call server delivers the ACK message to the called SIP terminal (step 319).

A communication path is established, i.e., busy, and the calling SIP terminal and the called SIP terminal transmit and receive RTP media packets to and from each other so that a voice call and a video call for the SIP call are established (step 320).

When the SIP call is established in step 320, the calling SIP terminal transmits a keep-alive message, i.e., an INFO message to the SIP call server according to the transmission period information included in the 100 trying message, which is received from the SIP call server in step 313 (step 321). The keep-alive message may be either an arbitrary message defined by those skilled in the art or a message defined in the SIP standard. For convenience of illustration, it is assumed that the keep-alive message is the INFO message defined in the SIP.

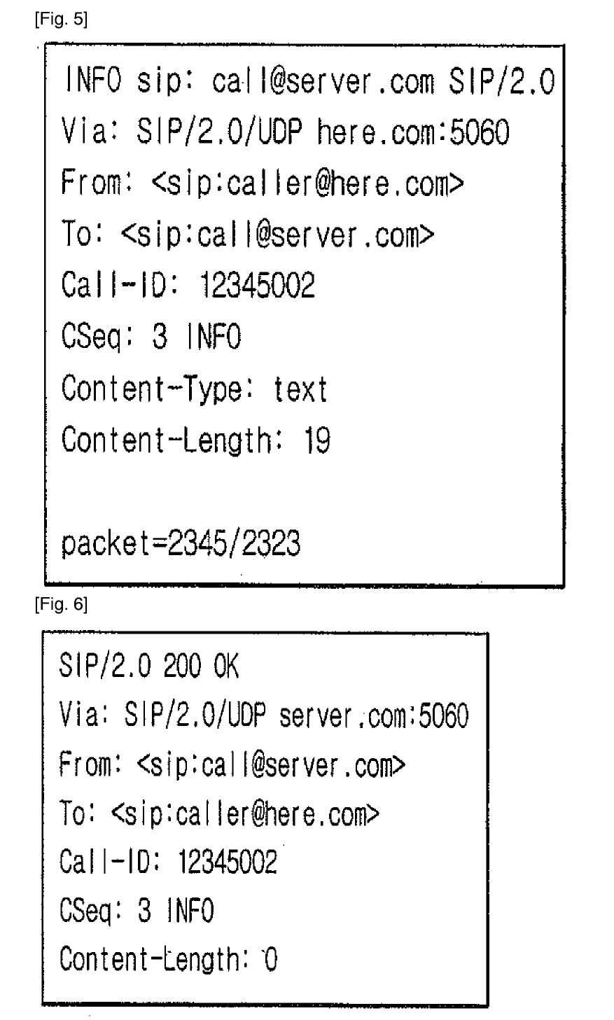

The INFO message includes billing information of the SIP call accumulated in the calling mobile terminal. Referring to FIG. 5, “packet=2345/2323” on a last line of the format of the INFO message indicates the billing information, in which “2345” indicates an amount of transmitted packets and “2323” indicates an amount of received packets.

The calling SIP terminal according to the first exemplary embodiment of the present invention can measure an amount of data packets (RTP media packets) transmitted and received to and from the called SIP terminal when the SIP call is established. The calling SIP terminal may also transmit the keep-alive message, i.e., an INFO message including the billing information, which includes the measured amount of packets, to the SIP call server in the transmission period. The billing information, i.e., a packet amount of the keep-alive message transmitted in the transmission period may be measured in each transmission period or accumulated after the SIP call is established. The calling SIP terminal may include an application for performing the above-described operation according to the first exemplary embodiment of the present invention.

Referring back to FIG. 3, upon receipt of the INFO message, the SIP call server transmits a response message, i.e., a 200 OK message to the calling SIP terminal (step 322). Now, one keep-alive confirmation procedure is completed. The 200 OK message may have a format shown in FIG. 6. The keep-alive confirmation procedure may be performed several times depending on the transmission period information during the SIP call establishment.

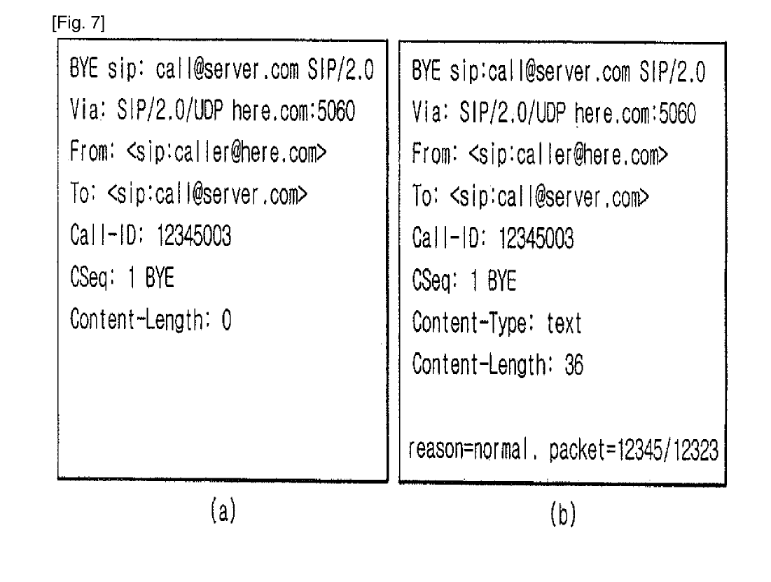

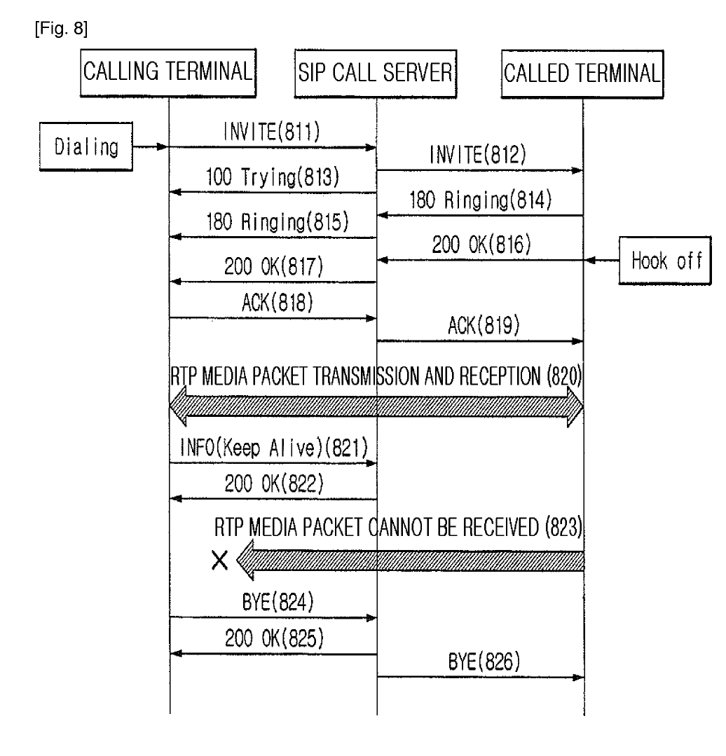

When the calling SIP terminal user hooks on, the calling SIP terminal transmits a BYE message to the SIP call server in order to terminate the SIP call (step 323). Herein the terminate may be replaced with release . The BYE message includes SIP call termination information and accumulated billing information. The BYE message according to the present invention has a different format from a general BYE message. This will be described with reference to FIG. 7.

FIG. 7 illustrates an exemplary format of the BYE message according to the first exemplary embodiment of the present invention.

FIG. 7(a) shows a format of a BYE message including only a content defined in a general SIP standard, and FIG. 7(b) shows a format of the BYE message according to the present invention. The BYE message shown in FIG. 7(b) may include call termination information and billing information when the SIP call is terminated by the calling SIP terminal.

As shown in FIG. 7(b), “reason=normal” and “Packet=12345/12323” on a last line of the format of the BYE message indicate the call termination information and the billing information, respectively. Specifically, “reason=normal” indicates that a call is normally terminated, and in “packet=12345/12323”, “12345” indicates an accumulated amount of packets transmitted by the calling SIP terminal and “12323” indicates an accumulated amount of packets received by the calling SIP terminal. The call termination information indicates normal call termination and may be arbitrarily defined by those skilled in the art.

Returning to FIG. 3, upon receipt of the BYE message, the SIP call server transmits a response message, i.e., a 200 OK message to the calling SIP terminal (step 324). The SIP call server also transmits the BYE message to the called SIP terminal (step 325). When receiving the BYE message, the called SIP terminal transmits a response message, i.e., a 200 OK message to the SIP call server, thereby terminating the SIP call (step 326).

Upon the termination of the SIP call, the SIP call server may transmit the call termination information and the billing information included in the BYE message, which is received from the calling SIP terminal in step 323, to a billing server. The billing server may calculate final billing information of the calling SIP terminal for the SIP call based on the call termination information and the billing information, and levy the calculated charge on the calling SIP terminal user.

As such, the charge for the calling terminal may be calculated based on either the billing information included in the INFO message (i.e., a keep-alive message) or the billing information included in the BYE message. Specifically, the SIP call server immediately transmits the billing information included in the keep-alive message, which is received from the calling terminal in the transmission period, to the billing server, which may accumulate and calculate the billing information for the calling terminal. The billing server may calculate final billing information for the calling terminal based on the billing information included in the BYE message.

The BYE message transmitted by the calling SIP terminal in step 323 as described above includes the billing information. That is, the BYE message includes the billing information for the calling SIP terminal as the SIP call is established. The billing information also includes an amount of data packets (RTP media packets) that the calling SIP terminal transmits and receives to and from the called SIP terminal while the SIP call is being established. The amount of packets may be recorded in an additional field of the BYE message.

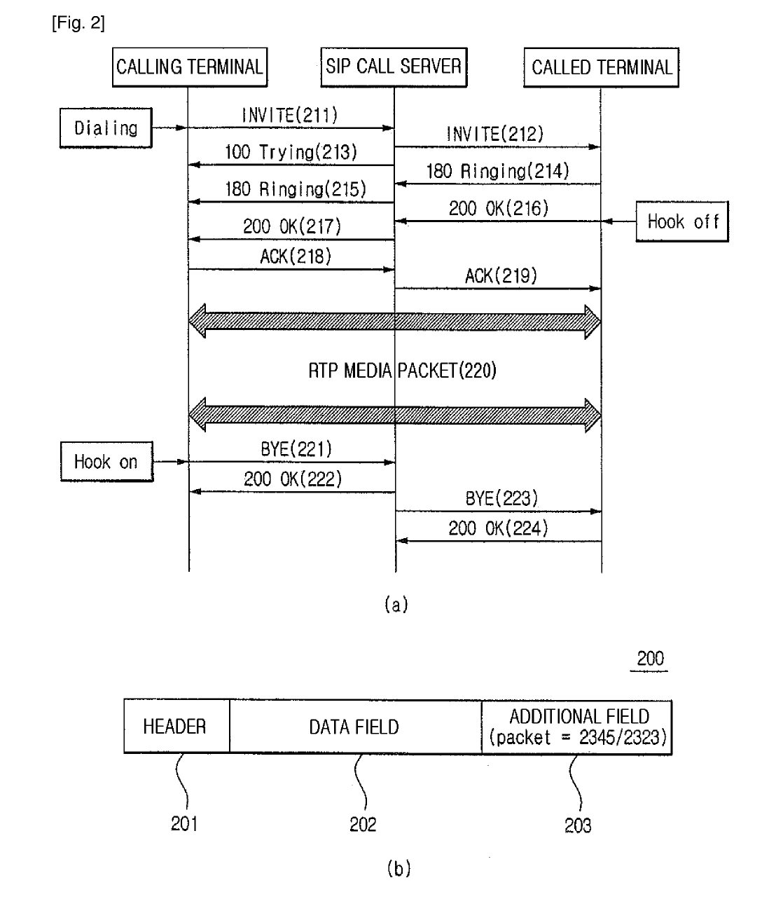

FIG. 2(b) shows a structure of the BYE message 200. According to the first exemplary embodiment of the present invention, the BYE message 200 that the calling SIP terminal transmits to the SIP call server in step 221 may include a header 201, a data field 202, and an additional field 203. The billing information, i.e., the packet amount information of the calling SIP terminal may be recorded in the additional field 203.

As shown in FIG. 2(b), the billing information, “packet=2345/2323”, may be recorded in the additional field 203. Here, “2345” may indicate an amount of packets transmitted by the calling SIP terminal, and “2323” may indicate an amount of packets received by the calling SIP terminal. The BYE message 200 shown in FIG. 2(b) is only an example for convenience of illustration and may be changed into several formats by those skilled in the art. That is, the BYE message that the calling SIP terminal transmits to the SIP call server in step 323 may have any structure or format only if it includes the billing information of the calling SIP terminal.

As described above, according to the first exemplary embodiment of the present invention, the calling SIP terminal can record the billing information in the BYE message and transmit it to the SIP call server. Specifically, when the SIP call is established, the calling SIP terminal continues to measure an amount of RTP media packets that it transmits and receives to and from the called SIP terminal. When a call termination event such as hook-on by the user occurs, the calling SIP terminal records the finally accumulated billing information (packet amount) in the additional field of the BYE message. The calling SIP terminal transmits the BYE message including the final billing information to the SIP server in order to terminate the SIP call. The calling SIP terminal may include an application for performing the above-described operation according to the first exemplary embodiment of the present invention.

As described above, according to the first exemplary embodiment of the present invention, the SIP call server can obtain the billing information of the calling terminal as an amount of packets actually used by the calling terminal. That is, the server does not obtain the billing information of the calling terminal based on an SIP call establishment duration as in the conventional art, but on a data packet amount that the calling terminal actually transmits and receives to and from the called terminal as the SIP call is established, thus enabling more efficient and reasonable billing. The concept that the billing information is obtained from the amount of packets transmitted and received as the SIP call is established is applied to all of other exemplary embodiments of the present invention that will be described later.

According to the first exemplary embodiment of the present invention described in FIGS. 3 to 7, an SIP call server often checks a call establishment state, i.e., a keep-alive state of the calling SIP terminal, which is a billing object of the SIP call establishment, and levies a charge that depends on the state, thereby enabling more rational billing.

FIG. 8 is a flowchart illustrating a method for controlling billing in an SIP call server according to a second exemplary embodiment of the present invention.

In the second exemplary embodiment of the present invention, the method for controlling billing in the SIP call server when the calling SIP terminal does not receive the RTP media packet from the called SIP terminal while the SIP call is kept established between the calling SIP terminal and the called SIP terminal will be described.

When the calling SIP terminal user dials to establish an SIP call, the calling SIP terminal transmits an SIP call initiation message, i.e., an invite message to the SIP call server (step 811). The SIP call server then transmits an invite message, which includes a content of the invite message received from the calling SIP terminal, to the called SIP terminal (step 812).

The SIP call server transmits a 100 trying message to the calling SIP terminal in order to inform that it is ready to perform the SIP call establishment (step 813). The 100 trying message includes information on a transmission period of a keep-alive message that the calling SIP terminal transmits during communication. The 100 trying message may have the same format as the 100 trying message according to the first exemplary embodiment of the present invention shown in FIG. 4(b).

Upon receipt of the invite message from the SIP call server, the called SIP terminal rings a bell and simultaneously transmits a 180 Ringing message to the SIP call server in order to inform that the SIP call can be established (step 814). The SIP call server delivers the 180 Ringing message to the calling SIP terminal (step 815). Upon receipt of the 180 Ringing message, the calling SIP terminal outputs a ringback tone.

When a user of the called SIP terminal hooks off, the called SIP terminal transmits a 200 OK message to the SIP call server in order to attempt to establish the SIP call (step 816). The SIP call server delivers the 200 OK message to the calling SIP terminal (step 817).

The calling SIP terminal transmits an ACK message to the SIP call server in order to inform that a final response message, i.e., a 200 OK message to the invite message has been received (step 818), and the SIP call server delivers the ACK message to the called SIP terminal (step 819).

A communication path is established, i.e., busy, and the calling SIP terminal and the called SIP terminal transmit and receive RTP media packets to and from each other so that a voice call and video call for the SIP call are established (step 820).

The calling SIP terminal transmits a keep-alive message, i.e., an INFO message to the SIP call server according to the transmission period information included in the 100 trying message, which is received from the SIP call server in step 813 (step 821). The INFO message includes billing information of the SIP call accumulated in the calling SIP terminal. The INFO message may have the same format as the INFO message according to the first exemplary embodiment of the present invention shown in FIG. 5.

The calling SIP terminal according to the second exemplary embodiment of the present invention may include an application for performing the above-described operation, like the calling SIP terminal according to the first exemplary embodiment of the present invention.

Upon receipt of the INFO message, the SIP call server transmits a response message, i.e., a 200 OK message to the calling SIP terminal (step 822). Now, one keep-alive confirmation procedure may be completed. The keep-alive confirmation procedure may be performed several times depending on the transmission period information during the SIP call establishment.

In the keep-alive confirmation procedure, when the calling SIP terminal does not receive the RTP media packet from the called SIP terminal for a predetermined time (step 823), the calling SIP terminal transmits the BYE message to the SIP call server (step 824). In step 824, the BYE message may include call termination information and billing information, as in the first exemplary embodiment of the present invention.

The calling SIP terminal and the called SIP terminal according to the second exemplary embodiment of the present invention may include an application for allowing the terminals to check whether the RTP media packet is received from each other.

Upon receipt of the BYE message, the SIP call server transmits the 200 OK message to the calling SIP terminal (step 825) and the BYE message to the called SIP terminal (step 826). Accordingly, the SIP call may be terminated. However, the called SIP terminal may not receive the BYE message. In this case, the called SIP terminal itself may terminate the SIP call when the RTP media packets are not transmitted or received for a predetermined period of time.

Upon termination of the SIP call, the SIP call server transmits the call termination information and the billing information, which are included in the BYE message received from the calling SIP terminal in step 824, to the billing server. The billing server may calculate final billing information of the calling SIP terminal for the SIP call based on the call termination information and the billing information and levy the calculated charge on the calling SIP terminal user.

As described above, according to the second exemplary embodiment of the present invention described in FIG. 8, when the calling SIP terminal cannot receive the RTP media packet due to malfunction of the called SIP terminal while SIP call is established, the calling SIP terminal transmits the BYE message to the SIP call server to terminate the SIP call. This enables billing by an actually used amount and minimizes waste of communication network resources.

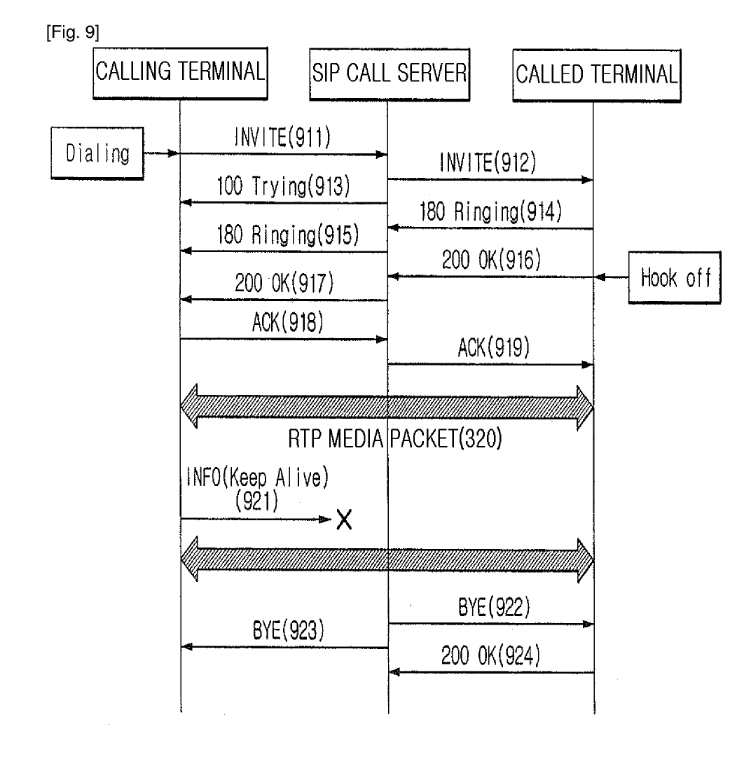

FIG. 9 is a flowchart illustrating a method for controlling billing in an SIP call server according to a third exemplary embodiment of the present invention.

In the third exemplary embodiment of the present invention, the method for controlling billing in the SIP call server when the SIP call server does not receive the keep-alive message, i.e., an INFO message from the calling SIP terminal while the SIP call is kept established between the calling SIP terminal and the called SIP terminal will be described.

When the calling SIP terminal user dials to establish an SIP call, the calling SIP terminal transmits an SIP call initiation message, i.e., an invite message to the SIP call server (step 911). The SIP call server then transmits an invite message, which includes a content of the invite message received from the calling SIP terminal, to the called SIP terminal (step 912).

The SIP call server also transmits a 100 trying message to the calling SIP terminal in order to inform that it is ready to perform the SIP call establishment (step 913). The 100 trying message includes information on a transmission period of a keep-alive message that the calling SIP terminal transmits during communication. The 100 trying message may have the same format as the 100 trying message according to the first exemplary embodiment of the present invention shown in FIG. 4(b).

Upon receipt of the invite message from the SIP call server, the called SIP terminal rings a bell and simultaneously transmits a 180 Ringing message to the SIP call server in order to inform that the SIP call can be established (step 914). The SIP call server delivers the 180 Ringing message to the calling SIP terminal (step 915). Upon receipt of the 180 Ringing message, the calling SIP terminal outputs a ringback tone.

When a user of the called SIP terminal hooks off, the called SIP terminal transmits a 200 OK message to the SIP call server in order to attempt to establish the SIP call (step 916). The SIP call server delivers the 200 OK message to the calling SIP terminal (step 917).

The calling SIP terminal transmits an ACK message to the SIP call server in order to inform that a final response message, i.e., a 200 OK message to the invite message has been received (step 918), and the SIP call server delivers the ACK message to the called SIP terminal (step 919).

A communication path is established, i.e., busy, and the calling SIP terminal and the called SIP terminal transmit and receive RTP media packets to and from each other so that a voice call and video call for the SIP call are established (step 920).

The calling SIP terminal transmits a keep-alive message, i.e., an INFO message to the SIP call server according to the transmission period information included in the 100 trying message, which is received from the SIP call server in step 913 (step 921). The INFO message includes billing information of the SIP call accumulated in the calling mobile terminal. The INFO message may have the same format as the INFO message according to the first exemplary embodiment of the present invention shown in FIG. 5. The calling SIP terminal according to the third exemplary embodiment of the present invention may include the same application as the calling SIP terminal according to the first exemplary embodiment of the present invention.

When the SIP call server does not receive the INFO message from the calling SIP terminal in the transmission period, the SIP call server transmits the BYE message to the called SIP terminal (step 922). That is, the SIP call server determines that the SIP call establishment of the calling SIP terminal is abnormal and transmits the BYE message to the called SIP terminal in order to terminate the SIP call.

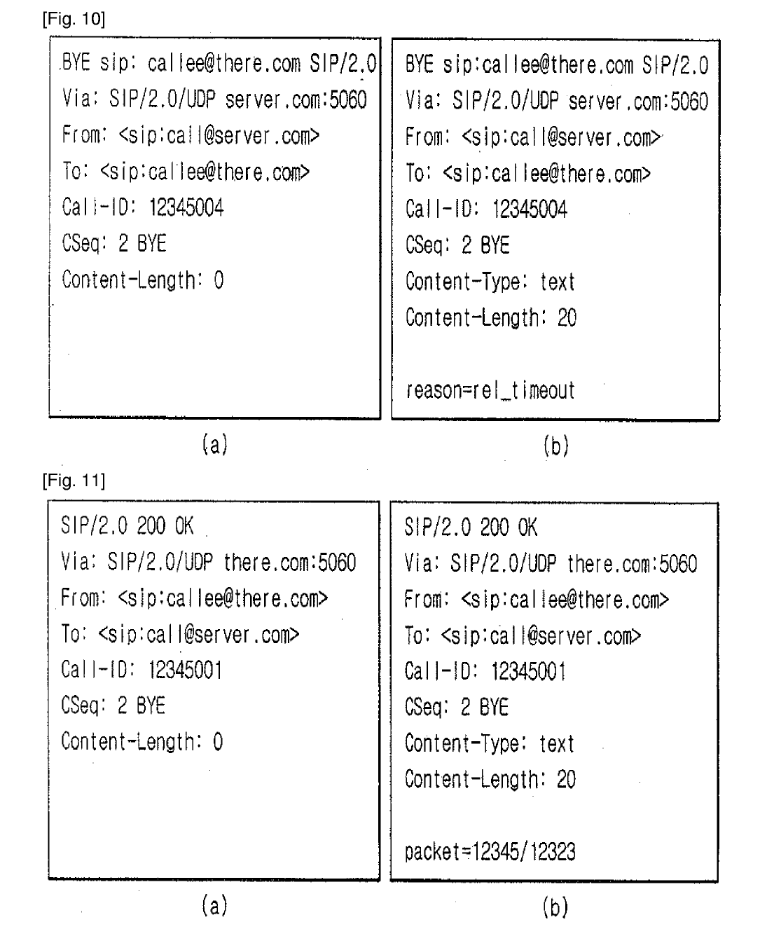

The BYE message transmitted to the called SIP terminal in step 922 includes SIP call termination information. This will be described with reference to FIG. 10.

FIG. 10 illustrates an exemplary format of a BYE message according to a third exemplary embodiment of the present invention.

FIG. 10(a) shows a format of a BYE message which includes only a content defined in a general SIP standard, and FIG. 10(b) shows a format of a BYE message according to the third exemplary embodiment of the present invention. In FIG. 10(b), the BYE message may include call termination information when the SIP call of the calling SIP terminal is terminated.

As shown in FIG. 10(b), “reason=rel_timeout” on a last line of the format of the BYE message is the call termination information, which indicates that the call is abnormally terminated. The format of the call termination information may be arbitrarily determined by those skilled in the art

Returning to FIG. 9, the called SIP terminal transmits a 200 OK message to the SIP call server in response to the BYE message (step 924). The 200 OK message includes accumulated billing information of the called SIP terminal for the SIP call. This will be described with reference to FIG. 11.

FIG. 11 illustrates an exemplary format of a 200 OK message according to a third exemplary embodiment of the present invention.

FIG. 11(a) shows a format of a 200 OK message which includes only a content defined in a general SIP standard, and FIG. 11(b) shows a format of a 200 OK message according to the third exemplary embodiment of the present invention. In FIG. 11(b), the 200 OK message may include call termination information when the SIP call of the calling SIP terminal is terminated.

As shown in FIG. 11(b), “packet=12345/12323” on a last line of the format of the 200 OK message indicates the accumulated billing information. “12345” indicates an accumulated amount of transmitted packets in bytes and “12323” indicates an accumulated amount of received packets in bytes. The billing information of the called SIP terminal may be used to calculate billing information of the calling SIP terminal for the SIP call.

Returning to FIG. 9, in response to the 200 OK message received from the called SIP terminal, the SIP call server may terminate the SIP call between the calling SIP terminal and the called SIP terminal. Upon termination of the SIP call, the SIP call server transmits the billing information, which is included in the 200 OK message received from the called SIP terminal in step 924, to the billing server. The billing server may calculate final packet billing information for the calling SIP terminal based on the billing information of the called SIP terminal included in the 200 OK message.

As described above, according to the third exemplary embodiment of the present invention described in FIGS. 9 to 11, when the SIP call server cannot receive the keep-alive message, i.e., an INFO message, any further due to malfunction of the calling SIP terminal while SIP call is kept established, the SIP call server can control the SIP call termination and calculate a charge to be levied on the calling SIP terminal based on the billing information received from the called SIP terminal. This enables more rational billing and minimizes waste of communication network resources.

The method for controlling billing in an SIP call server according to the first, second, and third exemplary embodiments of the present invention have been described with reference to FIGS. 1 to 11.

The first exemplary embodiment is directed to the method for controlling billing in the SIP call server when the SIP call established between the calling SIP terminal and the called SIP terminal is normally terminated as the user of the calling SIP terminal hooks on, the second exemplary embodiment is directed to the method for controlling billing in the SIP call server when the calling SIP terminal does not receive the RTP media packet from the called SIP terminal while the SIP call is kept established between the calling SIP terminal and the called SIP terminal, and the third exemplary embodiment is directed to the method for controlling billing in the SIP call server when the SIP call server does not receive the keep-alive message, i.e., an INFO message from the calling SIP terminal while the SIP call is kept established between the calling SIP terminal and the called SIP terminal

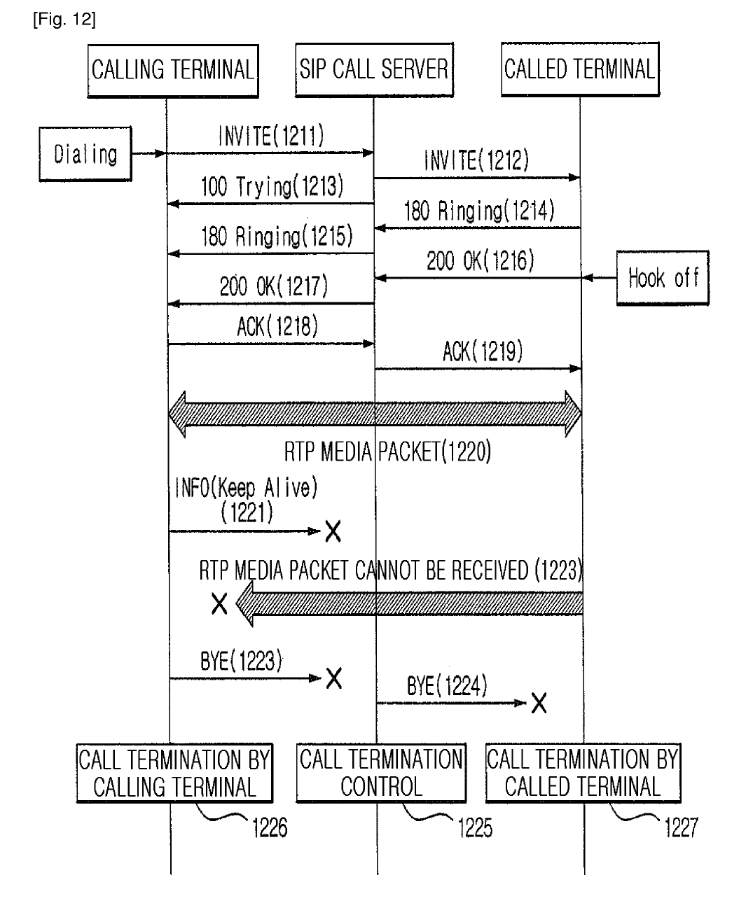

FIG. 12 is a flowchart illustrating a method for controlling billing in an SIP call server according to a fourth exemplary embodiment of the present invention.

Steps 1211 to 1220 are the same as in the first to third exemplary embodiments of the present invention, and accordingly, a detailed description thereof will be omitted.

The fourth exemplary embodiment of the present invention is directed to a method for controlling billing in an SIP call server when both abnormal call terminations as in the second and third exemplary embodiments occur, i.e., when the calling SIP terminal does not receive the RTP media packet from the called SIP terminal and the SIP call server does not receive the keep-alive message from the calling SIP terminal while the SIP call is kept established.

In this case, the final packet billing information may be calculated based on the billing information included in the keep-alive message, i.e., an INFO message that the calling SIP terminal periodically transmits to the SIP call server until the above abnormal situation occurs. The SIP call server may record a reason for the abnormal call termination in the billing data.

Even though the calling SIP terminal transmits the INFO message, the SIP call server may not receive it due to a trouble in the call establishment of the calling SIP terminal (step 1221) and simultaneously, the calling SIP terminal may not receive the RTP media packet from the called SIP terminal due to a trouble in the call establishment of the called SIP terminal (step 1222).

Since the calling SIP terminal does not receive the RTP media packet from the called SIP terminal for a predetermined time, it transmits the BYE message to the SIP call server (step 1223). However, the SIP call server cannot receive the BYE message. Furthermore, the SIP call server transmits the BYE message to the called SIP terminal in order to obtain billing information (step 1224). However, the called SIP terminal cannot receive the BYE message and cannot transmit the 200 OK message including the billing information to the SIP call server.

Accordingly, the SIP call server determines that call establishment failure occurs in both the calling SIP terminal and the called SIP terminal and controls the SIP call termination. The calling SIP terminal and the called SIP terminal themselves terminate the SIP call.

The SIP call server may recognize billing information included in the INFO message finally received from the calling SIP terminal as final billing information for the calling terminal and transmit it to the billing server.

As described above, according to the fourth exemplary embodiment of the present invention, even when the billing information cannot be normally obtained as call failure occurs in both the calling SIP terminal and the called SIP terminal, billing for the calling terminal is performed based on the billing information finally transmitted by the calling SIP terminal. Thus, even in abnormal call termination, rational billing information can be obtained efficiently.

After the call is terminated, the SIP call server transmits a charge data record (CDR), such as the final packet billing information, the call termination reason information, the time billing information created by the SIP call server, and the like, to the billing server, so that a call charge can be calculated.

The billing server deletes the packet billing information of the call provided by the SIP call server from packet billing information of subscriber data service provided by the packet data serving node in order to obtain only the packet billing information of data service other than the SIP call service.

Although the exemplary embodiments have been described by terms of the call according to the SIP protocol, it will be apparent to those skilled in the art that the method for controlling billing according to the present invention may be applied to various VoIP protocols.

Furthermore, the calling SIP terminal or the called SIP terminal according to the present invention may include an application for measuring an amount of data packets (RTP media packets) transmitted and received to and from a correspondent terminal when the SIP call is established, and incorporating information on the measured amount of packets into various messages (e.g., a BYE message and a 200 OK message), which are transmitted and received to and from the SIP call server under the SIP call establishment control. By the application, the packet amount information may be recorded in the additional field of each message. That is, various SIP call establishment messages according to the present invention may have the additional field in which the packet amount information is recorded.

The method for controlling billing in an SIP call server according to the present invention may be implemented as computer instructions which can be executed by various computer means, and recorded on a computer-readable medium. The computer-readable medium may include program commands, data files, data structures or a combination thereof. Program commands recorded on the medium may be particularly designed and structured for the present invention or made available to those skilled in computer software. Examples of the computer-readable recording medium include magnetic media, such as a hard disk, a floppy disk, and a magnetic tape; optical media, such as a compact disk-read only memory (CD-ROM) and a digital versatile disc (DVD); magneto-optical media, such as floptical disks; a read-only memory (ROM); a random access memory (RAM); and a flash memory. The medium may be a transmission medium, such as an optical or metal line, a waveguide, or carrier waves transferring program commands, data structures, and the like. Program commands may include, for example, a high-level language code that can be executed by a computer using an interpreter, as well as a machine language code made by a complier. Hardware described herein may be embodied as one or more software modules to implement the present invention.

The scope of the present invention should not be limited to the description of the exemplary embodiments and should be determined by the following claims and its equivalents.

1. A method for controlling billing in a Session Initiation Protocol (SIP) call server, the method comprising the steps of:
receiving an invite message from a calling SIP terminal;
transmitting a 100 trying message to the calling SIP terminal, the 100 trying message including transmission period information of a keep-alive message;
establishing an SIP call between the calling SIP terminal and a called SIP terminal, and receiving the keep-alive message from the calling SIP terminal in the transmission period, the keep-alive message including billing information; and
when the SIP call is terminated, transmitting final billing information received from the calling SIP terminal to a billing server.

2. The method according to claim 1, wherein the keep-alive message is an INFO message, and the billing information comprises an amount of RTP media packets that the calling SIP terminal transmits to the called SIP terminal and an amount of RTP media packets that receives from the called SIP terminal.

3. The method according to claim 1, further comprising the step of receiving a BYE message from the calling SIP terminal,
wherein the BYE message comprises call termination information and final billing information, the SIP call server transmits the call termination information and the final billing information to the billing server, and the billing server performs billing on the calling SIP terminal based on the final billing information as the SIP call is established.

4. The method according to claim 3, wherein the calling SIP terminal transmits the BYE message to the SIP call server when the RTP media packet is not received from the called SIP terminal for a predetermined time.

5. The method according to claim 4, wherein the called SIP terminal terminates the SIP call when the RTP media packet is not received from the calling SIP terminal for the predetermined time.

6. The method according to claim 1, wherein the calling SIP terminal transmits the keep-alive message to the SIP call server in the transmission period.

7. A method for controlling billing in an SIP call server, the method comprising the steps of:
receiving an invite message from a calling SIP terminal to establish an SIP call;
transmitting a 100 trying message to the calling SIP terminal, the 100 trying message including transmission period information of a keep-alive message;
when the SIP call is established between the calling SIP terminal and a called SIP terminal, determining whether the keep-alive message is received from the calling SIP terminal in the transmission period, and transmitting a BYE message to the called SIP terminal when the keep-alive message is not received in the transmission period;
receiving a 200 OK message including billing information from the called SIP terminal; and
transmitting the billing information to a billing server.

8. The method according to claim 7, wherein the BYE message comprises abnormal call termination information.

9. The method according to claim 7, wherein the billing information comprises an amount of RTP media transmission packets of the called SIP terminal transmitted to the calling SIP terminal and an amount of RTP media reception packets of the called SIP terminal received from the calling SIP terminal after the SIP call is established, and the billing server performs billing on the calling SIP terminal based on the billing information as the SIP call is established.

10. A method for controlling billing in an SIP call server, the method comprising the steps of:
receiving an invite message from a calling SIP terminal;
transmitting a 100 trying message to the calling SIP terminal, the 100 trying message including transmission period information of a keep-alive message;
establishing an SIP call between the calling SIP terminal and a called SIP terminal, and receiving the keep-alive message from the calling SIP terminal in a transmission period, the keep-alive message including billing information;
controlling termination of the SIP call when the keep-alive message is not received from the calling SIP terminal in the transmission period and a BYE message is not received for a predetermined time; and
transmitting billing information included in a final keep-alive message received from the calling SIP terminal to a billing server.

11. The method according to claim 10, wherein the calling SIP terminal transmits the BYE message including the billing information to the SIP call server when an RTP media packet is not received from the called SIP terminal for the predetermined time.

12. The method according to claim 11, wherein the calling SIP terminal or the called SIP terminal terminate the SIP call when they do not receive the RTP media packet from each other for the predetermined time.

13. A method for controlling billing in an SIP call server, the method comprising the steps of:
controlling SIP call establishment between a calling SIP terminal and a called SIP terminal;
controlling termination of the SIP call when a BYE message including billing information for the SIP call establishment is received from the calling SIP terminal; and
transmitting the billing information to a billing server.

14. The method according to claim 13, wherein the calling SIP terminal accumulates and measures an amount of transmission packets and an amount of reception packets transmitted to the called SIP terminal and an amount of reception packets received from the called SIP terminal after the SIP call is established, records billing information including a finally accumulated amount of the packets in an additional field of the BYE message when an SIP call termination event is generated, and transmits the resultant billing information to the SIP call server.

15. A method for controlling billing in an SIP terminal, the method comprising the steps of:
measuring an amount of data packets transmitted to a called SIP terminal and an amount of data packets received from the called SIP terminal when an SIP call is established with the called SIP terminal; and
transmitting a BYE message to an SIP call server to terminate the SIP call when an SIP call termination event is generated,
wherein the BYE message comprises billing information including a finally accumulated amount of packets.

16. The method according to claim 15, wherein when the SIP terminal does not receive an RTP packet from the called SIP terminal for a predetermined time after the SIP call is established, the SIP terminal determines that the SIP call termination event is generated and transmits the BYE message to the SIP call server.

17. A method for controlling billing in an SIP terminal, the method comprising the steps of:
receiving a 100 trying message including information on a transmission period of a keep-alive message from an SIP call server, the SIP call server controlling an SIP call establishment with a called SIP terminal;
measuring an amount of data packets transmitted to the called SIP terminal and an amount of data packets received from the called SIP terminal in the transmission period when the SIP call is established with the called SIP terminal; and
transmitting the keep-alive message to the SIP call server in the transmission period, wherein the keep-alive message comprises billing information including the measured amount of data packets.

18. A method for controlling billing in an SIP terminal, the method comprising the steps of:
measuring an amount of data packets transmitted to the calling SIP terminal and an amount of data packets received from the calling SIP terminal when an SIP call is established with the calling SIP terminal;
receiving a BYE message from an SIP call server to terminate the SIP call; and
transmitting a 200 OK message to the SIP call server,
wherein the 200 OK message comprises billing information including a finally accumulated and measured amount of packets.

19. The method according to claim 18, wherein the SIP call server transmits the BYE message to the SIP terminal when a keep-alive message including billing information is not received from the calling SIP terminal in a predetermined transmission period.

20. A computer-readable recording medium having a program recorded thereon for executing a method according to claim 1.
